(19) United States
(12) Patent Application Publication
(10) Pub. No.: US 2012/0055001 A1
(43) Pub. Date: Mar. 8, 2012

(54) MODULAR COUNTERTOP METHOD

(76) Inventor: Don Dunbar, Ponce Inlet, FL (US)

(21) Appl. No.: 13/291,472

(22) Filed: Nov. 8, 2011

Related U.S. Application Data
(62) Division of application No. 12/168,249, filed on Jul. 7, 2008.

(51) Int. Cl. B23P 11/00

(52) U.S. Cl. 29/428

(57) ABSTRACT

A method of installing a modular countertop includes a first step of determining a desired final size of a countertop at an installation site so that a modular countertop may be installed at the installation site; and a second step of trimming the modular countertop at the installation site from a first size to the desired final size to form the finished countertop, the modular countertop including a composite layer and a support layer bonded to the composite layer, the composite layer including a filler material dispersed within a polymer matrix, wherein the composite layer and the support layer have a combined thickness less than about 1.25 inches.

### REFERENCE TO RELATED MATTER

This application is a division of U.S. patent application Ser. No. 12/168,249, which was filed Jul. 7, 2008 and is incorporated herein by reference.

### BACKGROUND OF THE INVENTION

This disclosure relates to countertops and, more particularly, to a modular countertop that can be prepared for installation onsite and does not require custom preparation at a remote manufacturing facility.

Countertops, such as those installed in kitchens, baths, or the like, may be manufactured from a variety of different surfaces. For instance, the countertop may be formed from a laminate (e.g., Formica®), tile, a natural material (e.g., stone, marble, etc.), or a composite (e.g., Corian®). Typically, the countertop is custom manufactured using specialized manufacturing equipment at remotely located manufacturing facility to fit a particular space of an installation site. An installer may record measurements of the space, and a countertop manufacturer may then produce the countertop based on the measurements. For instance, the specialized manufacturing equipment may include CNC machinery to precisely cut joint surfaces, sink openings, and the like. Thus, there may be a significant lag time while the countertop manufacturer fabricates the custom countertop, and the use of the specialized equipment may add significant consumer cost to the countertop.

### SUMMARY OF THE INVENTION

An example method of installing a modular countertop includes a first step of determining a desired final size of a countertop at an installation site so that a modular countertop may be installed at the installation site; and a second step of trimming a modular countertop at the installation site from a first size to the desired final size to form the finished modular countertop, the modular countertop including a composite layer and a support layer bonded to the composite layer, the composite layer including a filler material dispersed within a polymer matrix, wherein the composite layer and the support layer have a combined thickness less than about 1.25 inches.

A further example includes a method of installing a plurality of modular countertops on-site. The method includes providing a plurality of countertops on-site, each of the plurality of countertops having a standard size, determining a first desired final size of one of the counter tops at a first installation location for installation of a first finished countertop; and trimming one of the plurality of countertops at the first installation location from the standard size to the first desired final size. The method further includes determining a second desired final size of one of the counter tops at a second installation location for installation of a second finished countertop; and trimming another of the plurality of countertops at the second installation location from the standard size to the second desired final size.

### BRIEF DESCRIPTION OF THE DRAWINGS

The various features and advantages of the disclosed examples will become apparent to those skilled in the art from the following detailed description. The drawings that accompany the detailed description can be briefly described as follows.

FIG. 1 illustrates an example modular countertop.

FIG. 2 illustrates a cross-section of the example modular countertop.

FIG. 3 illustrates an example of pieces cut from a modular countertop.

FIG. 4 illustrates an example modular countertop system.

FIG. 5 illustrates an example method of forming a finished countertop from a modular countertop.

FIG. 6 illustrates an example of capping an unfinished edge of a modular countertop.

### DETAILED DESCRIPTION OF THE PREFERRED EMBODIMENT

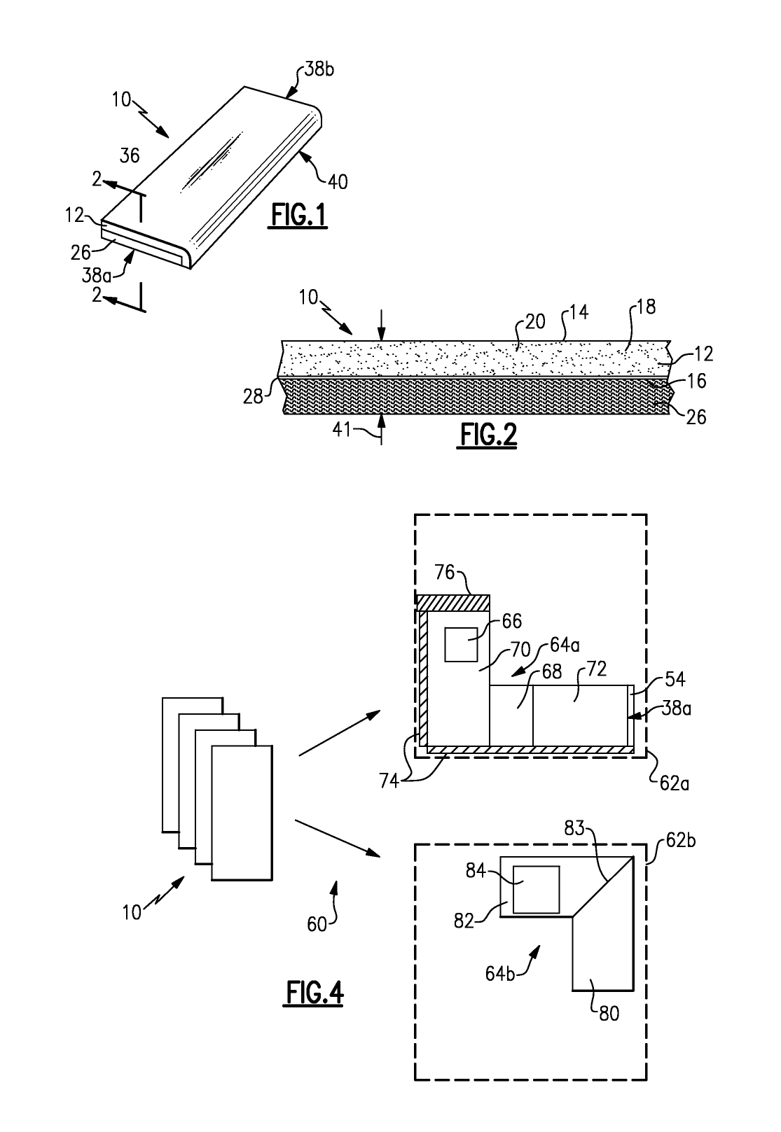

FIG. 1 illustrates an example modular countertop 10 that may be trimmed into a custom shape at any installation site using portable hand-held tools, for example. The modular countertop 10 thereby reduces time and expense of countertop installation.

Referring also to the cross-section of the modular countertop 10 shown in FIG. 2, the example modular countertop 10 includes a composite layer 12 having a top surface 14 and a bottom surface 16. The composite layer 12 includes a filler material 18 dispersed within a polymer matrix 20. For instance, the filler material 18 provides the composite layer 12 with a desired visual appearance, such as an appearance of a natural material (e.g., marble). In one example, the filler material 18 includes aluminum trihydrate to provide the natural material appearance. The polymer matrix 20 may be any polymer material suitable for a countertop, such as acrylic. Given this description, one of ordinary skill in the art will recognize other suitable types of polymers to meet their particular needs.

A support layer 26 is bonded to the bottom surface 16 of the composite layer 12. For example, the support layer 26 may be formed of any type of material suitable for mechanically supporting the composite layer 12. In one example, the support layer 26 is a wood fiber board, such as a medium density fiber board. As may be appreciated, the support layer 26 may alternatively be another type of engineered wood product and is not limited to wood fiber board.

In the illustrated example, the support layer 26 is bonded to the composite layer 12 using an adhesive layer 28. For example, the adhesive layer 28 may be any type of adhesive material that is suitable for permanently bonding the support layer 26 and the composite layer 12 together. In one example, the adhesive layer 28 includes epoxy, acrylic, or other polymeric adhesive.

The support layer 26 and the composite layer 12 of the modular countertop 10 extend between an unfinished back edge 36 (FIG. 1), opposed unfinished side edges 38a and 38b, and a finished front edge 40 (i.e., a “drop edge”). The composite layer 12 and the support layer 26 are exposed at the unfinished back edge 36 and each of the unfinished side edges 38a and 38b, and the finished front edge 40 does not expose any of the support layer 26. The finished front edge 40 may have a pre-existing radius, such as a 0.25 inch radius, formed during an initial manufacturing of the modular countertop 10 and may be about one inch thick. The side edges 38a or 38b may be trimmed at an installation site and left unfinished if the side edge 38a or 38b is not visually exposed. Alternatively, the modular countertop 10 may be provided with finished side edges that have been capped as described below, rather than the unfinished side edges 38a and 38b.

In this example, the finished front edge 40 is radiused to provide a desirable appearance. In some examples, a radius of about 0.25 inches provides the modular countertop 10 with a robust appearance. However, it is to be understood that the finished front edge 40 may be left square or finished differently to provide a different appearance. The finished front edge 40 may be formed using any suitable technique. In one example, the finished front edge 40 is formed by cutting a V-shaped groove into the bottom surface 16 of the composite layer 12.

The modular countertop 10 has a relatively thin total thickness 41 (FIG. 2). For example, the total thickness 41 is less than about 1.25 inches. The total thickness 41 in combination with the type of materials selected for the composite layer 12 and the support layer 26 allow the modular countertop 10 to be trimmed at an installation site using portable hand tools, such as a portable table saw, handheld jigsaw, or other type of cutting tool. In one example, the total thickness 41 may be about one inch, where the composite layer 12 and the support layer 26 are each about one-half inch thick and the adhesive layer 28 does not add significantly to the total thickness 41.

FIG. 3 illustrates an example of how the modular countertop 10 may be used at an installation site. For example, the modular countertop 10 may be cut into one or more pieces that are then used to form a final finished countertop at the installation site. For example, the modular countertop 10 may be cut into a finished countertop piece 50, a back splash piece 52, or an end cap piece 54. As may be appreciated, there may also be one or more scrap pieces 56 left over that are not used at the particular installation site. The scrap pieces 56 may be used at another installation site, for example.

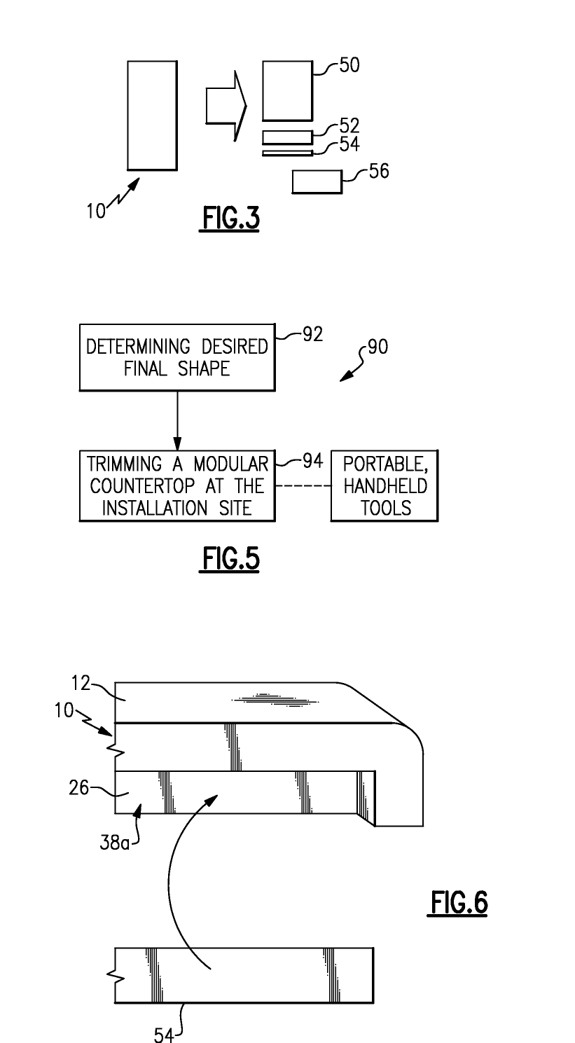

FIG. 4 illustrates an example modular countertop system 60 that utilizes a plurality of the modular countertops 10. For instance, the modular countertops 60 may be provided in a standard size and shape, or a variety of different standard colors, sizes and shapes. For example, a countertop manufacturer may provide the plurality of modular countertops 10 to a builder, distributor, or the like for use at different installation sites 62a and 62b.

The installation sites 62a and 62b may be building structures, such as an individual home site, an office building, or the like. As may be appreciated, the size and shape requirements for a finished countertop at each of the installation sites 62a and 62b may be different. In this regard, one or more of the plurality of modular countertops 10 may be used to construct a first finished countertop 64a having a first size and shape at the first installation site 62a and a second finished countertop 64b having a second shape and size that is different than the first shape and size at the second installation site 62b. It is to be understood that the first finished countertop 64a and the second finished countertop 64b are examples of different finished countertops and that the modular countertops 10 may be used to construct finished countertops having other shapes and sizes.

In the illustrated example, the first finished countertop 64a includes an opening 66 for accommodating a sink and a space 68 between a first countertop piece 70 and a second countertop piece 72 for accommodating a stove or the like. The first finished countertop 64a may also include a back splash 74 that runs along the back of the first countertop piece 70 and the second countertop piece 72. The back splash 74 may attached to a wall (e.g., using glue) or secured to the first countertop piece 70 and the second countertop piece 72. In this example, the first countertop piece 70 abuts a wall 76 on one end and the back splash 74 on its opposite end. The second countertop piece 72 abuts the space 68 on one end and is open on the other end.

To construct the first finished countertop 64a, the first countertop piece 70, the second countertop piece 72, the back splash 74, and the end cap piece 54 may be trimmed at the first installation site 62a from one or more of the plurality of modular countertops 10. For instance, portable hand-held tools may be used to cut the modular countertops 10 into the desired shape for assembling the first finished countertop 64a. The unfinished side edge 38a of the second countertop piece 72 may be capped using the end cap piece 54 to cover the exposed support layer 26 and provide a desired appearance. Thus, the modular countertop system 60 provides the benefit of immediate onsite installation of the first finished countertop 64a without lag time or expense for fabrication at a remotely located manufacturing facility using specialized equipment.

Likewise, one or more of the plurality of modular countertops 10 may be used to construct the second finished countertop 64b at the second installation site 62b. In this example, the second finished countertop 64b includes a first countertop piece 80 and a second countertop piece 82. The first countertop piece 80 and the second countertop piece 82 are each exposed on one end and abut at an angled joint 83 on the respective other ends. For instance, an adhesive, such as caulking, may be used to join the first countertop piece 80 and a second countertop piece 82 together at the angled joint 83 in a relatively inconspicuous manner. Although the end surfaces that form the angled joint 83 may not be manually trimmed as precisely as an automated CNC machine trimming process, most types of joints are visible and the joint 83 may provide a relatively similar appearance to a precisely trimmed joint. The second countertop piece 82 also includes an opening 84 for a sink.

Similar to the first installation site 62a, one or more of the plurality of modular countertops 10 may be trimmed into the desired shape and constructed onsite. Thus, there is no need to measure the spaces for the first finished countertop 64a or the second finished countertop 64b at the installation sites 62a and 62b for a custom manufacturing because the plurality of modular countertops 10 may be trimmed onsite and constructed into the desired shape for immediate installation of the finished countertops 64a and 64b.

FIG. 5 illustrates one example method 90 for forming a finished countertop. In this example, the method 90 includes a step 92 of determining a desired final shape and size at an installation site of a finished modular countertop and step 94 of trimming the modular countertop 10 at the installation site. The trimming at step 94 may be achieved using handheld portable tools. In one example, a space at an installation site may be measured to determine the desired final shape and size. Alternatively, an installer may make a template of the space and trim the modular countertop 10 using the template.

As discussed above, the combination of the selected materials of the composite layer 12 and the support layer 26 with the relatively thin total thickness 41 of the modular countertop 10 allows the modular countertop 10 to be trimmed at the installation site to the desired final shape and size to form the finished modular countertop (e.g., the first finished countertop 64a or the second finished countertop 64b).

FIG. 6 illustrates an example of capping one of the unfinished side edges 38a or 38b of the modular countertop 10. In this example, the end cap piece 54 has been trimmed from the modular countertop 10 and may be secured onto the unfinished side edge 38a. For instance, the composite layer 12 may be separated from the support layer 26 such that the end cap piece 54 includes only a strip of the composite layer 12. The end cap piece 54 may then be bonded to the unfinished side edge 38a to cover the exposed surface of the support layer 26. Thus, the support layer 26 would no longer be visible.

Although a combination of features is shown in the illustrated examples, not all of them need to be combined to realize the benefits of various embodiments of this disclosure. In other words, a system designed according to an embodiment of this disclosure will not necessarily include all of the features shown in any one of the Figures or all of the portions schematically shown in the Figures. Moreover, selected features of one example embodiment may be combined with selected features of other example embodiments.

The preceding description is exemplary rather than limiting in nature. Variations and modifications to the disclosed examples may become apparent to those skilled in the art that do not necessarily depart from the essence of this disclosure. The scope of legal protection given to this disclosure can only be determined by studying the following claims.

What is claimed is:

1. A method installing a modular countertop, said method comprising:
determining a desired final size of a countertop at an installation site so that a modular countertop may be installed at said installation site; and
trimming said modular countertop at the installation site from a first size to the desired final size to form the finished countertop, the modular countertop including a composite layer and a support layer bonded to the composite layer, the composite layer including a filler material dispersed within a polymer matrix, wherein the composite layer and the support layer have a combined thickness less than about 1.25 inches.

2. The method as recited in claim 1, wherein the determining of the desired final shape and size step includes measuring at the installation site.

3. The method as recited in claim 1, further comprising trimming the modular countertop using portable hand-held tools.

4. The method as recited in claim 1, wherein the trimming step includes cutting a piece off the modular countertop at the installation site and attaching the piece as an end cap on a cut edge of the modular countertop.

5. The method as recited in claim 1, wherein the trimming step includes cutting a final countertop piece, a back splash piece, or an end cap piece from the modular countertop.

6. The method as recited in claim 1, wherein the trimming includes cutting an unfinished side of the modular countertop.

7. The method as recited in claim 1, further comprising trimming a second modular countertop at the installation site to a second final size that is different than the final size of the modular countertop.

8. A method for installing a plurality of counter tops on-site, said method comprising:
providing a plurality of countertops on-site, each of said plurality of countertops having a standard size,
determining a first desired final size of one of said counter tops at a first installation location for installation of a first finished countertop; and
trimming one of said plurality of countertops at said first installation location from said standard size to said first desired final size,
determining a second desired final size of one of said counter tops at a second installation location for installation of a second finished countertop; and
trimming another of said plurality of countertops at said second installation location from said standard size to said second desired final size.

9. The method of claim 8 wherein each of said countertops has a composite layer and a support layer bonded to the composite layer, the composite layer including a filler material dispersed within a polymer matrix, wherein the composite layer and the support layer have a combined thickness less than about 1.25 inches.

10. The method as recited in claim 8, wherein the determining step include measuring at said first or second installation location.

11. The method as recited in claim 8, further comprising trimming the countertop using portable hand-held tools.

12. The method as recited in claim 8, wherein the trimming includes cutting a piece off the modular countertop at the installation site and attaching the piece as an end cap on a cut edge of the countertop.

13. The method as recited in claim 8, wherein said trimming step includes cutting a final countertop piece, a back splash piece, or an end cap piece from the countertop.

14. The method as recited in claim 8, wherein the trimming includes cutting an unfinished side of the modular countertop.

15. The method as recited in claim 8 wherein said first installation location and said second installation location are on-site.
